(19) United States
(12) Patent Application Publication
(10) Pub. No.: US 2025/0158752 A1
(43) Pub. Date: May 15, 2025

(54) RADIO LINK CONTROL ACKNOWLEDGEMENT MODE TIMING FOR MULTI MODAL TRAFFIC

(71) Applicant: QUALCOMM Incorporated, San Diego, CA (US)

(72) Inventors: Sitaramanjaneyulu KANAMARLAPUDI, San Diego, CA (US); Prasad Reddy KADIRI, San Diego, CA (US); Diana MAAMARI, San Diego, CA (US); Linhai HE, San Diego, CA (US)

(21) Appl. No.: 18/509,227

(22) Filed: Nov. 14, 2023

(51) Int. Cl. H04L 1/1829; H04L 1/1607

(52) U.S. Cl. CPC H04L 1/1854; H04L 1/1628

(57) ABSTRACT

Methods, systems, and devices for wireless communications are described. A network may configure one or more devices with a timer. The timer may define a threshold amount of time a receiver in a radio link control (RLC) acknowledgement mode (AM) is to wait for and continue to request retransmission of a missing RLC packet data unit (PDU) through automatic repeat request (ARQ) mechanisms. The receiver may detect a missing PDU, and may initiate two timers: a first timer defining how long the receiver is to request and monitor for the missing first PDU, and a second timer defining an amount of time before requesting retransmission of the first PDU. Upon expiration of the second timer, the receiver may transmit a request for retransmission of the first PDU. Upon expiration of the first timer, the receiver may forward all other sequentially received PDUs to higher layers for decoding.

### FIELD OF TECHNOLOGY

The following relates to wireless communications, including radio link control acknowledgement mode timing for multi modal traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support radio link control acknowledgement mode timing for multi modal traffic. For example, the network may configure one or more devices with a timer. The timer may define a threshold amount of time a receiver in a radio link control (RLC) acknowledgement mode (AM) is to wait for and continue to request retransmission of a missing RLC packet data unit (PDU) through automatic repeat request (ARQ) mechanisms. The receiver may monitor for PDUs, and if a PDU is missing (e.g., sequence numbers (SNs) higher than a first PDU are received but the first PDU SN is not yet received), then the receiver may initiate two timers: a first timer defining how long the receiver is to request and monitor for the missing first PDU, and a second timer defining an amount of time before requesting retransmission of the first PDU. Upon expiration of the second timer, the receiver may transmit a request for retransmission of the first PDU. In some examples, the receiver may transmit multiple requests for retransmission prior to expiration of the first timer (e.g., the second timer may be initiated and expire multiple times before expiration of the first timer). Upon expiration of the first timer, the receiver may set a status of the first missing PDU to received (e.g., may assume that the first missing PDU is received, despite not having received the first PDU), and may forward all other sequentially received PDUs to higher layers for decoding. The receiver may then move a receive window based on the forwarding, and may monitor for next PDUs having next highest SNs after the forwarded PDUs.

A method for wireless communications by a receiving device is described. The method may include receiving control signaling indicating a first timer corresponding to a radio link control acknowledgement mode, the first timer indicating a threshold amount of time during which the receiving device is to request and monitor for one or more missed packet data units, receiving one or more packet data units of a first set of packet data units, each packet data unit of the first set of packet data units corresponding to a respective sequence number, where at least a first packet data unit is missing from the first set of packet data units, initiating the first timer and a second timer upon detecting the first packet data unit is missing, transmitting, upon expiration of the second timer, a request for a retransmission of the first packet data unit according to the radio link control acknowledgement mode, and delivering the one or more packet data units to higher layers of the receiving device for decoding based on a failure to receive the first packet data unit and expiration of the first timer.

A receiving device for wireless communications is described. The receiving device may include one or more memories storing processor executable code, and one or more processors coupled with the one or more memories. The one or more processors may individually or collectively operable to execute the code to cause the receiving device to receive control signaling indicating a first timer corresponding to a radio link control acknowledgement mode, the first timer indicating a threshold amount of time during which the receiving device is to request and monitor for one or more missed packet data units, receive one or more packet data units of a first set of packet data units, each packet data unit of the first set of packet data units corresponding to a respective sequence number, where at least a first packet data unit is missing from the first set of packet data units, initiate the first timer and a second timer upon detecting the first packet data unit is missing, transmit, upon expiration of the second timer, a request for a retransmission of the first packet data unit according to the radio link control acknowledgement mode, and deliver the one or more packet data units to higher layers of the receiving device for decoding based on a failure to receive the first packet data unit and expiration of the first timer.

Another receiving device for wireless communications is described. The receiving device may include means for receiving control signaling indicating a first timer corresponding to a radio link control acknowledgement mode, the first timer indicating a threshold amount of time during which the receiving device is to request and monitor for one or more missed packet data units, means for receiving one or more packet data units of a first set of packet data units, each packet data unit of the first set of packet data units corresponding to a respective sequence number, where at least a first packet data unit is missing from the first set of packet data units, means for initiating the first timer and a second timer upon detecting the first packet data unit is missing, means for transmitting, upon expiration of the second timer, a request for a retransmission of the first packet data unit according to the radio link control acknowledgement mode, and means for delivering the one or more packet data units to higher layers of the receiving device for decoding based on a failure to receive the first packet data unit and expiration of the first timer.

A non-transitory computer-readable medium storing code for wireless communications is described. The code may include instructions executable by one or more processors to receive control signaling indicating a first timer corresponding to a radio link control acknowledgement mode, the first timer indicating a threshold amount of time during which the receiving device is to request and monitor for one or more missed packet data units, receive one or more packet data units of a first set of packet data units, each packet data unit of the first set of packet data units corresponding to a respective sequence number, where at least a first packet data unit is missing from the first set of packet data units, initiate the first timer and a second timer upon detecting the first packet data unit is missing, transmit, upon expiration of the second timer, a request for a retransmission of the first packet data unit according to the radio link control acknowledgement mode, and deliver the one or more packet data units to higher layers of the receiving device for decoding based on a failure to receive the first packet data unit and expiration of the first timer.

In some examples of the method, receiving devices, and non-transitory computer-readable medium described herein, the control signaling includes a radio link control configuration information including a semi-static value indicating a duration of the first timer.

In some examples of the method, receiving devices, and non-transitory computer-readable medium described herein, the control signaling includes a set of candidate timer durations.

Some examples of the method, receiving devices, and non-transitory computer-readable medium described herein may further include operations, features, means, or instructions for selecting, from the set of candidate timer durations, a duration of the first timer.

In some examples of the method, receiving devices, and non-transitory computer-readable medium described herein, the control signaling may include operations, features, means, or instructions for a first control message including a radio resource control message indicating a first duration of the first timer and a second control message including a media access control (MAC) control element (CE) indicating a second duration of the first timer, where the second duration of the first timer overrides the first duration of the first timer, and where initiating the first timer may be in accordance with the second duration of the first timer.

Some examples of the method, receiving devices, and non-transitory computer-readable medium described herein may further include operations, features, means, or instructions for adjusting a duration of the first timer based on one or more conditions, where initiating the first timer may be in accordance with the adjusted duration of the first timer.

In some examples of the method, receiving devices, and non-transitory computer-readable medium described herein, the one or more conditions include a block error rate corresponding to wireless communications in the radio link control acknowledgement mode, a round trip time corresponding to the wireless communications in the radio link control acknowledgement mode, or both.

In some examples of the method, receiving devices, and non-transitory computer-readable medium described herein, the control signaling includes a radio link control control packet data unit.

Some examples of the method, receiving devices, and non-transitory computer-readable medium described herein may further include operations, features, means, or instructions for monitoring for the first packet data unit based on transmitting the request for the retransmission of the first packet data unit, where the failure to receive the first packet data unit may be based on the monitoring and setting a status of the first packet data unit that may be missing to a received status based on expiration of the first timer, where delivering the one or more packet data units to the higher layers of the receiving device for decoding may be based on setting the status of the first packet data unit to the received status.

In some examples of the method, receiving devices, and non-transitory computer-readable medium described herein, a sequence number corresponding to the first packet data unit may be lower than at least one sequence number corresponding to another packet data unit of the one or more packet data units.

Some examples of the method, receiving devices, and non-transitory computer-readable medium described herein may further include operations, features, means, or instructions for monitoring for a second set of packet data units based on delivering the one or more packet data units to higher layers of the receiving device for decoding, where a lowest sequence number corresponding to a first packet data unit of the second set of packet data units may be higher than a highest sequence number corresponding to a second packet data unit of the first set of packet data units.

In some examples of the method, receiving devices, and non-transitory computer-readable medium described herein, the first set of packet data units correspond to multi-modal immersive reality communications including at least visual data and haptic data.

A method for wireless communications by a transmitting device is described. The method may include setting, based on one or more parameters, a duration of a first timer corresponding to a radio link control acknowledgement mode, the first timer indicating a threshold amount of time during which a receiving device is to request and monitor for one or more missed packet data units, transmitting control signaling indicating the first timer, transmitting a first set of packet data units, each packet data unit of the first set of packet data units corresponding to a respective sequence number, receiving a request for a retransmission of a first packet data unit of the first set of packet data units according to the radio link control acknowledgement mode, and retransmitting the first packet data unit according to the radio link control acknowledgement mode.

A transmitting device for wireless communications is described. The transmitting device may include one or more memories storing processor executable code, and one or more processors coupled with the one or more memories. The one or more processors may individually or collectively operable to execute the code to cause the transmitting device to setting, base at least in part on one or more parameters, a duration of a first timer corresponding to a radio link control acknowledgement mode, the first timer indicating a threshold amount of time during which a receiving device is to request and monitor for one or more missed packet data units, transmit control signaling indicating the first timer, transmit a first set of packet data units, each packet data unit of the first set of packet data units corresponding to a respective sequence number, receive a request for a retransmission of a first packet data unit of the first set of packet data units according to the radio link control acknowledgement mode, and retransmit the first packet data unit according to the radio link control acknowledgement mode.

Another transmitting device for wireless communications is described. The transmitting device may include means for setting, based on one or more parameters, a duration of a first timer corresponding to a radio link control acknowledgement mode, the first timer indicating a threshold amount of time during which a receiving device is to request and monitor for one or more missed packet data units, means for transmitting control signaling indicating the first timer, means for transmitting a first set of packet data units, each packet data unit of the first set of packet data units corresponding to a respective sequence number, means for receiving a request for a retransmission of a first packet data unit of the first set of packet data units according to the radio link control acknowledgement mode, and means for retransmitting the first packet data unit according to the radio link control acknowledgement mode.

A non-transitory computer-readable medium storing code for wireless communications is described. The code may include instructions executable by one or more processors to setting, base at least in part on one or more parameters, a duration of a first timer corresponding to a radio link control acknowledgement mode, the first timer indicating a threshold amount of time during which a receiving device is to request and monitor for one or more missed packet data units, transmit control signaling indicating the first timer, transmit a first set of packet data units, each packet data unit of the first set of packet data units corresponding to a respective sequence number, receive a request for a retransmission of a first packet data unit of the first set of packet data units according to the radio link control acknowledgement mode, and retransmit the first packet data unit according to the radio link control acknowledgement mode.

In some examples of the method, transmitting devices, and non-transitory computer-readable medium described herein, the control signaling includes a radio link control configuration information including a semi-static value indicating the duration of the first timer.

In some examples of the method, transmitting devices, and non-transitory computer-readable medium described herein, the control signaling includes a set of candidate timer durations including the duration of the first timer.

In some examples of the method, transmitting devices, and non-transitory computer-readable medium described herein, the control signaling may include operations, features, means, or instructions for a first control message including a radio resource control message indicating an initial duration of the first timer and a second control message including a MAC control element (CE) indicating the duration of the first timer, where the duration of the first timer overrides the initial duration of the first timer.

In some examples of the method, transmitting devices, and non-transitory computer-readable medium described herein, the control signaling includes RLC control PDU.

In some examples of the method, transmitting devices, and non-transitory computer-readable medium described herein, the one or more parameters include quality of service parameters, wireless traffic parameters, quality of service flow identifiers, or any combination thereof.

Some examples of the method, transmitting devices, and non-transitory computer-readable medium described herein may further include operations, features, means, or instructions for monitoring for a second request for the retransmission of the first packet data unit according to the radio link control acknowledgement mode for the duration of the first timer and transmitting a second set of packet data units based on the monitoring.

### BRIEF DESCRIPTION OF THE DRAWINGS

FIG. 1 shows an example of a wireless communications system that supports radio link control acknowledgement mode timing for multi modal traffic in accordance with one or more aspects of the present disclosure.

FIG. 2 shows an example of a wireless communications system that supports radio link control acknowledgement mode timing for multi modal traffic in accordance with one or more aspects of the present disclosure.

FIG. 3 shows an example of a timeline that supports radio link control acknowledgement mode timing for multi modal traffic in accordance with one or more aspects of the present disclosure.

FIG. 4 shows an example of a process flow that supports radio link control acknowledgement mode timing for multi modal traffic in accordance with one or more aspects of the present disclosure.

FIGS. 5 and 6 show block diagrams of devices that support radio link control acknowledgement mode timing for multi modal traffic in accordance with one or more aspects of the present disclosure.

FIG. 7 shows a block diagram of a communications manager that supports radio link control acknowledgement mode timing for multi modal traffic in accordance with one or more aspects of the present disclosure.

FIG. 8 shows a diagram of a system including a device that supports radio link control acknowledgement mode timing for multi modal traffic in accordance with one or more aspects of the present disclosure.

FIGS. 9 and 10 show block diagrams of devices that support radio link control acknowledgement mode timing for multi modal traffic in accordance with one or more aspects of the present disclosure.

FIG. 11 shows a block diagram of a communications manager that supports radio link control acknowledgement mode timing for multi modal traffic in accordance with one or more aspects of the present disclosure.

FIG. 12 shows a diagram of a system including a device that supports radio link control acknowledgement mode timing for multi modal traffic in accordance with one or more aspects of the present disclosure.

FIGS. 13 through 16 show flowcharts illustrating methods that support radio link control acknowledgement mode timing for multi modal traffic in accordance with one or more aspects of the present disclosure.

### DETAILED DESCRIPTION

Some wireless communications systems may support extended reality (XR) or virtual reality (VR) deployments. In such examples, a transmitting device may send multi-modal wireless communications to a receiving device. For example, the transmitting device may send high resolution visual data (e.g., video frames) to the receiving device, and my also transmit haptic data to one or more haptic sensors (e.g., wearable devices such as goggles, headsets, gloves, handsets, headsets, among other examples). In some examples, the transmissions may be sent to a single device, or multiple receiving devices. Such wireless communications may rely on stringent latency and reliability thresholds. Radio link control (RLC) communications may support communications at some layers (e.g., layer 2). For example, RLC acknowledgment mode (UM) may support low latency communications (e.g., as a receiving device may not be expected to send any feedback signaling upon reception from a transmitting device). However, such low latency may be achieved at the cost of reliability (e.g., as no mechanism in RLC UM is provided to request missing packet data units (PDUs)). Similarly, RLC acknowledgement mode (AM) may support high reliability communications (e.g., as the receiving device may utilize feedback signaling to request retransmission of unreceived PDUs). However, in RLC AM, the receiving device may continue to request and monitor for retransmission indefinitely (e.g., resulting in extended delays and increased system latency in some cases). XR wireless communications, which utilize both high resolution visual data signaling, and additional signaling for haptic sensors (e.g., XR communications in a multi-modal deployment) may fail (e.g., haptic sensor data may not align with visual data) without both high reliability and low latency.

The network may configure one or more devices with a timer (e.g., which may be referred to as a first timer, an automatic repeat request (ARQ) timer, a move receive window (MRW) timer, or may be referred to as T-arq_mrw timer). The timer may define a threshold amount of time a receiver in RLC AM is to wait for and continue to request retransmission of a missing RLC PDU through ARQ mechanisms. The receiver may monitor for PDUs, and if a PDU is missing (e.g., sequence numbers (SNs) higher than a first PDU are received but the first PDU SN is not yet received), then the receiver may initiate two timers: a first timer defining how long the receiver is to request and monitor for the missing first PDU, and a second timer defining an amount of time before requesting retransmission of the first PDU. Upon expiration of the second timer, the receiver may transmit a request for retransmission of the first PDU. In some examples, the receiver may transmit multiple requests for retransmission prior to expiration of the first timer (e.g., the second timer may be initiated and expire multiple times before expiration of the first timer). Upon expiration of the first timer, the receiver may set a status of the first missing PDU to received (e.g., may assume that the first missing PDU is received, despite not having received the first PDU), and may forward all other sequentially received PDUs to higher layers for decoding. The receiver may then move a receive window based on the forwarding, and may monitor for next PDUs having next highest SNs after the forwarded PDUs.

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to radio link control acknowledgement mode timing for multi modal traffic.

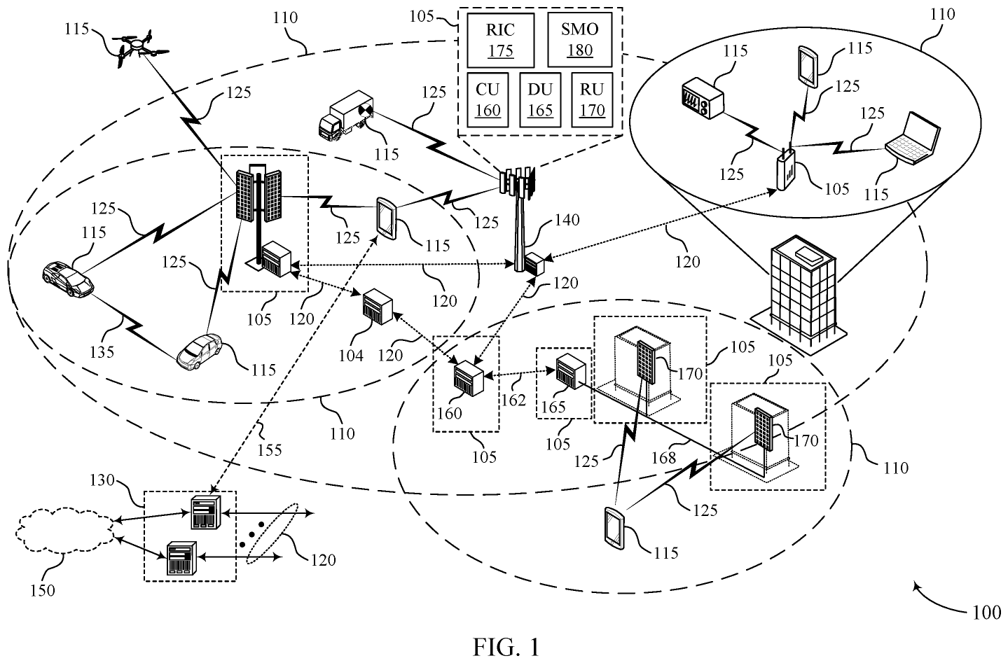

FIG. 1 shows an example of a wireless communications system 100 that supports radio link control acknowledgement mode timing for multi modal traffic in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support radio link control acknowledgement mode timing for multi modal traffic as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The network (e.g., a network entity 105) may configure one or more devices with a timer. The timer may define a threshold amount of time a receiver in a radio link control RLC AM is to wait for and continue to request retransmission of a missing PDU through ARQ mechanisms. The receiver may monitor for PDUs, and if a PDU is missing (e.g., SNs higher than a first PDU are received but the first PDU SN is not yet received), then the receiver may initiate two timers: a first timer defining how long the receiver is to request and monitor for the missing first PDU, and a second timer defining an amount of time before requesting retransmission of the first PDU. Upon expiration of the second timer, the receiver may transmit a request for retransmission of the first PDU. In some examples, the receiver may transmit multiple requests for retransmission prior to expiration of the first timer (e.g., the second timer may be initiated and expire multiple times before expiration of the first timer). Upon expiration of the first timer, the receiver may set a status of the first missing PDU to received (e.g., may assume that the first missing PDU is received, despite not having received the first PDU), and may forward all other sequentially received PDUs to higher layers for decoding. The receiver may then move a receive window based on the forwarding, and may monitor for next PDUs having next highest SNs after the forwarded PDUs.

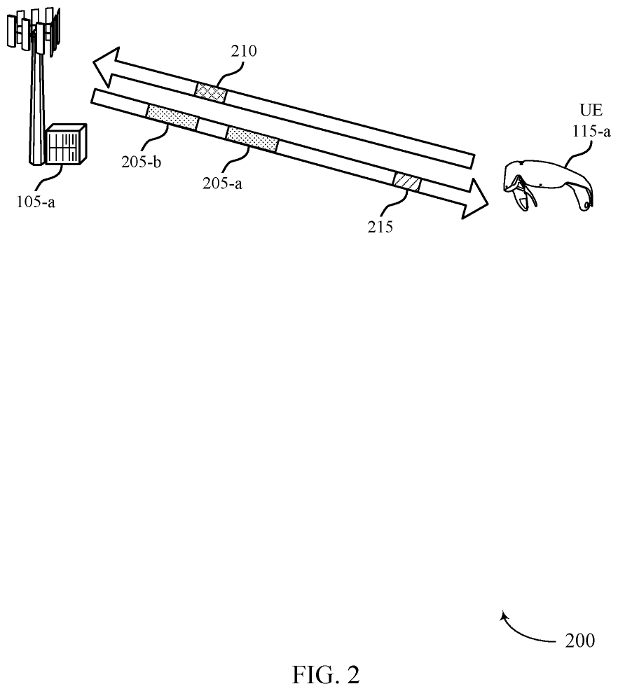

FIG. 2 shows an example of a wireless communications system 200 that supports radio link control acknowledgement mode timing for multi modal traffic in accordance with one or more aspects of the present disclosure. The wireless communications system 200 may implement, or be implemented by, aspects of the wireless communications system 100. For example, the wireless communications system may include a network entity 105-a, and a UE 115-a, which may be examples of corresponding devices described with reference to FIG. 1. Although as described with reference to FIG. 2, the network entity 105-a may be a transmitting device and the UE 115-a may be a receiving device, techniques described herein may apply to any transmitting and receiving device. For example, techniques described herein may apply to uplink transmissions from the UE 115-a to the network entity 105-a (e.g., in which case the network entity 105-a may determine when to shift a receive window and cease requesting retransmission from the UE 115-a using the first timer, as described herein). Similarly, techniques described herein may apply to transmissions between devices (e.g., from a primary or controlling UE 115-a, a gaming system, or the like, to one or more devices such as goggles, gloves, handsets, etc.). In some examples, transmissions from the network entity 105-a may be sent to a single receiving device, or multiple receiving devices (e.g., to a handset, a set of gloves, a set of goggles, a headset, or any combination thereof). Each receiving device may respond separately as described herein, or a single device may coordinate communication across multiple UEs 115.

In some examples, the wireless communications system 200 may support XR systems. Techniques described herein may support improved traffic reliability and lower latency for a wide range of unpredictable traffic, such as haptic traffic (e.g., sensor data), along with video traffic as part of a multi-modal traffic flow, which may improve overall XR user experience. XR traffic may rely on both high reliability that satisfies a threshold and low latency that satisfies a threshold. In some examples, key performance indicators (KPIs), or quality of service (QOS) parameters, may be different for different traffic flows based on the nature of traffic, and other codec characteristics. XR techniques described herein may support power savings, increased capacity, and improved performance.

A transmitting device (e.g., the network entity 105-a) may transmit signaling (e.g., PDUs 205) to a receiving device (e.g., the UE 115-a). XR signaling may support a threshold latency and threshold reliability. However, the signaling may include both data signaling, such as video frames, and haptic data (e.g., vibrations, airflow, pressure, or other sensory data provided via goggles, gloves, wearable devices, environmental sensors, or the like). Haptic data reliability and latency thresholds may be more stringent than video data, and may also be less consistent (e.g., more bursty). For example, video modal communications may be expected to support a 99% reliability at no more than a 10 ms latency, and haptic modal communication may be expected to support a 99.999% reliability at no more than a 5 ms latency.

In some examples, to address strict latency expectations, a receiving device may be configured to operate in an RLC UM, resulting in no additional delays at layer 2 with any ARQ mechanisms, and only a second timer (e.g., which may be referred to as a T-reassembly timer) as a guard timer before delivering packets to upper layers for decoding. This may result in RLC UM solely depending on HARQ feedback mechanisms for transmission and retransmission reliability, with negative impacts on application QOS criteria. For example, because RLC UM does not include an ARQ mechanism, latency may decrease, but reliability may suffer.

In some examples, to improve reliability, a receive device may be configured to operate in an RLC AM. In addition to HARQ reliability, such a device may also support ARQ mechanisms which improve reliability for recovering lost packets through RLC status PDU based retransmissions. For instance the UE 115-a may miss a transmission of a first PDU 205-a, and may transmit a request for retransmission (e.g., request 210). The request 210 may trigger retransmission of the missed PDU, and the network entity 105-a may retransmit the PDU (e.g., the PDU 205-b). However, if the UE 115-a still fails to receive the retransmission of the missed PDU, the UE 115-a may continue to request retransmission multiple times. In fact, the UE 115-a operating in an RLC AM may wait for any number of retransmissions to recover a lost PDU until either successful retransmission (e.g., after an extended delay) or until the UE 115-a initiates a radio link failure (RLF). Such consistent pursuit of lost PDUs may improve reliability, but may have a negative impact on latency for all PDUs which are successfully received in the case of one or more missing PDUs in a larger receive window. That is, if the UE 115-a receives a PDU with a SN 1 during a receive window, and receives additional PDUs with SNs of 3 through 10 during the same receive window, then the UE 115-a may continue to request retransmission of the PDU with the SN 2, without sending the successfully received PDUs with SNs of 3 through 10 to higher layers for decoding. If the UE 115-a does not have any mechanism for moving the receive window (e.g., such that an initial boundary of the receive window aligns with SN 3) after some number of retransmissions, then the UE 115-a may simply experience significantly increased latency, despite successfully receiving multiple PDUs subsequent to the missed PDU. Thus, RLC UM may improve latency at the cost of reliability, but RLC AM may improve reliability at the cost of indefinitely increased latency. XR communications with rigid reliability and latency thresholds may experience increased latency, failed transmissions or retransmission, and in some cases failed XR experience for the user.

Similarly, many approaches to improve HARQ reliability (e.g., duplicated PDUs at a PDCP level, conservative MCS, or the like) may impact a system level throughput, or a capacity of a cell. For example, a lack of PDU set presence, starting, or ending information at a RAN entity may result in inferior KPIs from a PDU set QOS perspective, because the RAN entity may not be able etc. make any adjustments to scheduling policies, etc. Mechanisms to adapt scheduler behavior, such as codec adjustments, alternative QoS, Low Latency Low Loss Scalable Throughput (L4S) mechanism, or the like, may result in increased latency (e.g., 100 ms).

Thus, as described herein, without a mechanism to support both stringent reliability and latency threshold (e.g., especially for multi modal traffic), XR systems may fail. Techniques described herein provide flexibility to leverage aspects of both RLC AM and RLC UM, while ensuring that the receiving device does not indefinitely request and monitor for retransmissions of missed PDUs.

As described herein, a receiving device (e.g., the UE 115-a) operating in an RLC AM may receive one or more PDUs 205, but may detect a loss of a transmitted PDU 205-a. The receiving device (e.g., the UE 115-a) may start a second timer (e.g., the T-reassembly timer) upon detection of the missed PDU 205-a. Upon expiration of the T-reassembly timer (e.g., and if there is no Status prohibit timer running), then the UE 115-a may transmit a request 210 (e.g., an RLC control PDU with negative acknowledgement (NAK) or acknowledgement (ACK) information indicating which PDUs (e.g., which segments) are requested for retransmission). In some examples, such requests (e.g., indicating NAK for the PDU 205-a) may continue until the PDU is received successfully or the transmitter gives up based on a threshold quantity of retransmissions to result in RLF. However, according to techniques described herein, the UE 115-a may also initiate a first timer upon detection of a lost PDU 205-a, and the first timer may limit how long the UE 115-a requests retransmission and waits for retransmission of a missed PDU.

The first timer may be referred to as an ARQ timer, a MRW timer, or as timer T-arq_mrw. The first timer may guard a threshold amount of time that an RLC AM entity (e.g., the receiver device, such as the UE 115-a) may request retransmission and wait for a missed PDU 205-a (e.g., a lost RLC SN) through ARQ mechanisms. In some examples, the default value for the first timer (e.g., if not explicitly configured or enabled by the network entity 105-a) may be infinite (e.g., in which case the UE 115-a may operate similar to mechanisms associated with an RLC UM).

The UE 115-a may monitor for and receive one or more PDUs 205. The UE 115-a may communicate in an RLC AM in downlink, and may receive packets accordingly. The UE 115-a may detect a missing PDU 205-a (e.g., may receive another PDU 205 with a higher (e.g., out of sequence) SN than the SN of the PDU 205-a). The UE 115-a may initiate the second timer (e.g., the T-reassembly timer) for uplink control PDU transmission (e.g., a timer after which the UE 115-a may transmit the request 210). Upon expiration of the T-reassembly timer, the RLC entity (e.g., the UE 115-a) may transmit the request 210 (e.g., may initiate the RLC control PDU in uplink (e.g., if the status prohibit timer is not running). Until the first timer (e.g., the T-arq_mrw timer) expires, the UE 115-a may transmit any number of requests 210 (e.g., may transmit the RCL control PDU including the request for retransmission of the PDU 205-a). Upon expiration of the first timer, the RLC AM entity (e.g., the UE 115-a) may assume that all SNs for which the timer is expired are received. For example, the UE 115-a may set the status of the PDU 205-a as received, despite the fact that the UE 115-a has not yet successfully received the PDU 205-a. In such examples, based on the implicit assumption that the missed PDU 205-a has been received, the UE 115-a may deliver the PDUs which are waiting for in sequence deliver in an RLC receive window, and may move the left edge (e.g., an initial or starting boundary) of the RLC receive window to a next expected RLC PDU that is to be received.

For instance, during an RLC receive window, the UE 115-a may receive PDUs with SNs 1, and 3-10. Based on reception of the PDU with SN 3, the UE 115-a may detect that the PDU with SN 2 is missing. While the first timer is running, the UE 115-a many transmit one or more requests 210 for retransmission of the lost PDU with SN 2. However, upon expiration of the first timer, if the UE 115-a has still not received the PDU with SN 2, then the UE 115-a may set a status of the PDU with SN 2 to indicate that is has been received (e.g., may assume that the PDU with SN 2 has been received, even though hit has not been), and may deliver other received in-sequence PDUs (e.g., the PDU with SN 1 and PDUs with SNs 3 through 10) to higher layers for decoding. The UE 115-a may then shift the starting boundary of the RLC receive window to the next expected RLC PDU to be received (e.g., PDU with SN 11).

In some examples, the first timer (e.g., T-arq_mrw) may be indicated via higher layer signaling (e.g., may be included as part of a resource block configuration), and may be an optional parameter. If the parameter is not configured, then the value for the first timer may be assumed to be infinite (e.g., in which case, the UE 115-a may operate as if in an RLC AM behavior without limit to the quantity of retransmissions requested). In some examples, the network entity 105-a may configure the first timer duration to be a zero value, in which case the RLM AM entity (e.g., the UE 115-a) may operate as if in an RLC UM (e.g., in terms of RLC ARQ level behavior and window management).

By managing the duration of the first timer (e.g., to any value from zero to infinite) may provide the wireless communication system 200 with greater flexibility to change RLC behavior between UM and AM of operations, without changing any other parameters or reconfiguration procedures. Such changes may be performed based on traffic mapping, channel information, corresponding QOS values, or other conditions or parameters. For example, in cases where traffic congestion occurs or interference increases, the network entity 105-a may configure a longer duration for the timer, increasing reliability of wireless signaling. In cases where traffic is low and packet losses are uncommon, the network entity 105-a may configure the duration of the first timer to be short, resulting in decreased latency without a significant cost in reliability.

As described herein, the network may configure the first timer, or the duration of the first timer, via control signaling. In cases where the network entity 105-a is the transmitting device and the UE 115-a is the receiving device, the network entity 105-a may transmit the control signaling to the UE 115-a, indicating the duration of the first timer, defining the first timer, or both. In some examples (e.g., where the network entity 105-a is the receiving device and the UE 115-a is the transmitting device), the network entity 105-a may select a duration of the first timer, and may perform the techniques described herein using the selected timer duration (e.g., may send PDUs for decoding even in the case of a missed PDU, and shift the starting boundary of an RLC receive window to a next expected SN, upon expiration of the selected duration of the first timer). In some examples, the network entity 105-a may determine the duration of the first timer, and provide it to multiple UEs 115, or to a controlling device (e.g., may configure one or more multiple UEs with the duration of the first timer, and the receiving device may utilize the timer value in communication with each other where one device such as a gaming system or a first UE 115 is the transmitting device described herein and another UE 115 such as XR goggles or gloves is the receiving device described herein).

The network entity 105-a ay transmit control signaling 215, which may include information about the first timer, the second timer, or both. For example, the control signaling 215 may include a semi-static value (e.g., the network entity 105-a may indicate the value of the first timer as a semi-static value through RCL configuration or reconfiguration parameters). Periodically, the network entity 105-a may indicate, update, or activate the semi-static value of the first timer via RLC configuration or reconfiguration parameters. In some examples, multiple values of the first timer (e.g., multiple candidate durations) may be configured to an RLC AM entity (e.g., the UE 115-a) and the RLC entity may select a value based on one or more parameters (e.g., quality of service flow identifiers (QFIs) mapped or QOS parameters of flows mapped to a particular RLC entity). In some examples, the network entity 105-a may transmit control signaling overriding a previously configured timer value. For example, a media access control (MAC) control element (CE) may override a previously configured durations of the first timer. A gNB indication (e.g., a MAC-CE transmitted by the network entity 105-a) may indicate an updated duration of the timer based on (e.g., or considering) a type of active traffic presence (e.g., haptic traffic, sensor traffic, flexible traffic, video traffic, among other examples). For example, the network entity 105-a may configure the UE 115-a with a first duration for the first timer for a first type of traffic, and may subsequently transmit a MAC-CE message indicating a new (e.g., updated) duration for the first timer for a second type of traffic.

In some examples, the value (e.g., duration) of the first timer may be adjusted at the RLC level based on one or more current conditions (e.g., a round trip time (RTT) experienced by the UE 115-a, a block error rate (BLER) experienced by the UE 115-a, a quantity of implicitly received PDUs assumed according to techniques described herein, or any combination thereof, among other examples).

The first timer (e.g., the T-arq_mrw timer) described herein may be equally applicable in uplink for PDUs received at the network entity 105-a from the UE 115-a. Upon expiration of the first timer, the network entity 105-a may also assume implicit reception of a missed PDU, and may move the RLC receive window accordingly. Such logic and techniques are equally applicable to either a UE 115, or to the network side, as part of RLC AM behavior for ARQ procedures (e.g., the network entity 105-a may be the transmitting device or the receiving device, and likewise the UE 115-a may be the transmitting device or the receiving device, as described herein).

In some examples, a receiving device (e.g., a UE 115) may report capability information to the network (e.g., the network entity 105-a), and the network entity may select and indicate a duration of the first timer based on the capability of the UE 115.

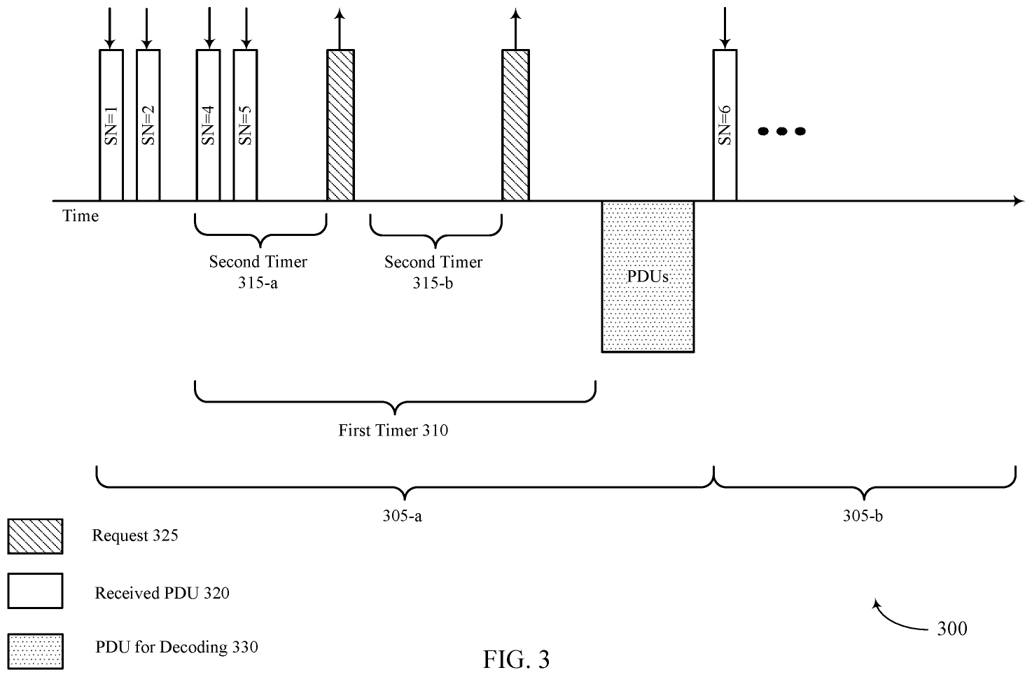

FIG. 3 shows an example of a timeline 300 that supports radio link control acknowledgement mode timing for multi modal traffic in accordance with one or more aspects of the present disclosure. Timeline 300 may implement, or be implemented by, aspects of the wireless communications system 100 and the wireless communications system 200. For example, a receiving device (e.g., such as the network entity 105 or a UE 115 as described with reference to FIG. 1 and FIG. 2) may receive one or more PDUs according to the timeline 300.

The receiving device may receive one or more PDUs 320, each PDU 320 corresponding to a SN, during an RLC receive window 305 (e.g., the receive window 305-a). For example, the receiving device may receive PDUs 320 having SNs 1, 2, 4, and 5. The receiving device may detect a missing PDU. For instance, upon receiving the PDU with SN 4, the receiving device may determine that it has missed (e.g., failed to receive) a PDU with SN 3. Upon detecting the lost PDU, the receiving device may initiate a first timer 310 and a second timer 315-a. The receiving device may continue to monitor for and receive one or more PDUs 320 (e.g., the PDU with SN 5) while the first timer 310 runs, and while the second timer 315-a runs. Upon expiration of the second timer 315-a, the receiving device may transmit a request 325 for retransmission of the missed PDU (e.g., the PDU with SN 3). In some examples, if the receiving device fails to receive the retransmission of the missed packet, then (e.g., prior to expiration of the first timer 310) the receiving device may initiate another instance of the second timer 315 (e.g., the second timer 315-b). Upon expiration of the second timer 315-b, the receiving device may transmit another request 325 for the missed PDU. Depending on the duration of the first timer 310 (e.g., and the duration of the second timer 315), the receiving device may transmit multiple requests 325 for the retransmission prior to expiration of the first timer 310.

Upon expiration of the first timer 310, the receiving device may send in-sequence PDUs for decoding 330 to higher layers (e.g., may send in-sequence PDUs received during the receive window 305-a to higher layers for decoding). For example, upon expiration of the first timer 310, the receiving device may proceed as if the missed PDU with SN 3 had been successfully received (e.g., may assume that the missed PDU has been received, or may set a status of the missed PDU with SN 3 to received, even though the receiving device has not received the PDU with SN 3 during the receive window 305-a). The receiving device may send the PDUs with SNs 1, 2, 4 and 5 to higher layers for decoding, and may move the starting boundary (e.g., left edge) of the receive window 305 to a next expected SN. For instance, the receiving device may shift the receive window 305-a to the receive window 305-b, and begin monitoring for a next expected SN (e.g., the PDU with SN 6).

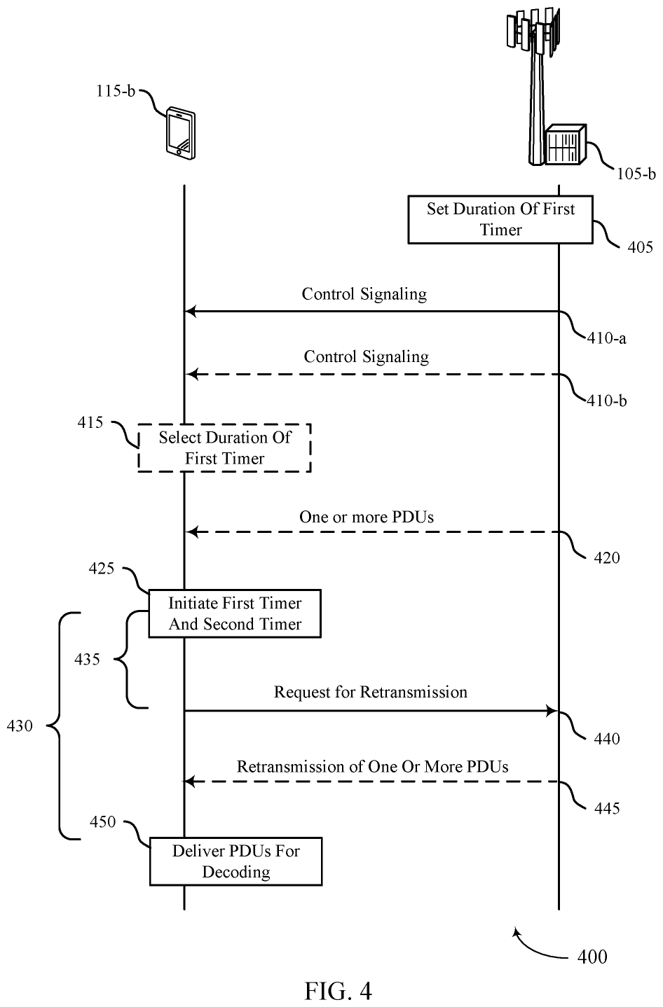

FIG. 4 shows an example of a process flow 400 that supports radio link control acknowledgement mode timing for multi modal traffic in accordance with one or more aspects of the present disclosure. The process flow 400 may implement, or be implemented by, aspects of the wireless communications system 100, the wireless communications system 200, or the timeline 300. For example, the process flow may include a UE 115-b and a network entity 105-b, which may be examples of corresponding devices described with reference to FIGS. 1-3.

At 405, the network entity 105-b may set a duration of a first timer (e.g., T-arq_mrw) corresponding to an RLC AM (e.g., the UE 115-b may be configured to operate in an RLC AM mode).

At 410, the UE 115-b may receive (e.g., from the network entity 105-b), control signaling indicating the first timer corresponding to the RLC AM. The first timer may indicate a threshold amount of time during which a receiving device (e.g., the UE 115-b) is to request and monitor for one or more missed PDUs.

In some examples, the control signaling may include RRC configuration information (e.g., RB configuration or reconfiguration) including a semi-static value indicating a duration of the first timer. For example, a first RRC message may configure an initial value (e.g., duration) of the timer at 410-a, and a second RRC message (e.g., at 410-b) may indicate an updated value (e.g., duration) for the first timer. In some examples, one or more durations for the first timer may be semi-statically indicated, and subsequent control messages may dynamically activate one of the candidate durations for the first timer.

In some examples, the control signaling at 410 may indicate a set of candidate timer durations. In such examples, at 415, the UE 115-b may select a duration of the first timer from the set of candidate timer durations. In such examples, the UE 115-b may perform the selection based on one or more parameters or conditions, such as channel quality, current traffic conditions, one or more thresholds for reliability of latency, a type of communication, or QOS parameters, among other examples.

In some examples, control signaling at 410-b may indicate an updated or overriding value (e.g., duration) for the first timer. For example, at 410-a the UE 115-b may receive first control signaling (e.g., RRC signaling) indicating a first (e.g., initial or default) duration for the first timer. At 410-b, the UE 115-b may receive a second control message (e.g., a MAC-CE message) indicating a second duration of the first timer. The second duration may override the first duration (e.g., the MAC-CE may dynamically update or override RRC configured durations for the first timer).

In some examples, the UE 115-b may autonomously adjust (e.g., select) a duration of the first timer (e.g., at 415) based on one or more conditions. Such conditions may include a BLER, an RRT, or the like. For example, the UE 115-b may receive an initial value for the first timer (e.g., at 410-a, 410-b, or both), and may then adjust the duration of the first timer based on the one or more conditions. In some examples, the UE 115-b may adjust the duration of the first timer by up to a threshold amount (e.g., which may be defined in one or more standards documents or indicated to the UE 115-b via control signaling).

In some examples, the control signaling (e.g. at 410-a, 410-b, or both) may be an RLC control PDU, including an indication of a duration of the first tier.

At 420, the UE 115-b may monitor for and receive one or more PDUs. The PDUs may correspond to multi-modal XR communications, among other examples. Each PDU may correspond to an SN. In some examples at least one PDU may be missing from a set of PDUs (e.g., as described in greater detail with reference to FIG. 3). For example, a SN corresponding to the first missing PDU may be lower than at least one SN of another PDU received at 420, indicating a missed PDU.

At 425, the UE 115-b may initiate a first timer and a second timer (e.g., upon detection of the missing first PDU). For example, the UE 115-b may initiate the timer 430 and the timer 435. Upon expiration of the timer 435 (e.g., the second timer), the UE 115-b may transmit a request for retransmission (e.g., at 440). The network entity 105-b may send a retransmission of the one or more missed PDUs (e.g., the first PDU) at 445 (e.g., if the network entity 105-b receives the request for retransmission at 440). In some examples, the UE 115-b may fail to receive the retransmission at 445. The UE 115-b may initiate and run the second timer 435 any number of times (e.g., and transmit any number of requests for retransmission) during the timer 430.

At 450, upon expiration of the timer 430, the UE 115-b may deliver one or more PDUs to higher layers of the UE 115-b for decoding (e.g., based on a failure to receive the first PDU, and based on expiration of the first timer 430). For example, the UE 115-b may monitor for the first PDU based on having transmitted the request for retransmission of the first PDU. If the UE 115-b has not received the first PDU (e.g., at 445), when the timer 430 expires, the UE 115-b may set a status of the first PDU that is missing to a received status. The UE 115-b may deliver the one or more received PDUs (e.g., received at 420) to the higher layers of the device for decoding based on having set the status of the missed PDU to received (e.g., as illustrated in greater detail with reference to FIG. 3, the UE 115-b may send all in-sequence and received PDUs during an RLC receive window to higher layers for decoding, and may then move the starting boundary of the RLC receive window to the next expected SN).

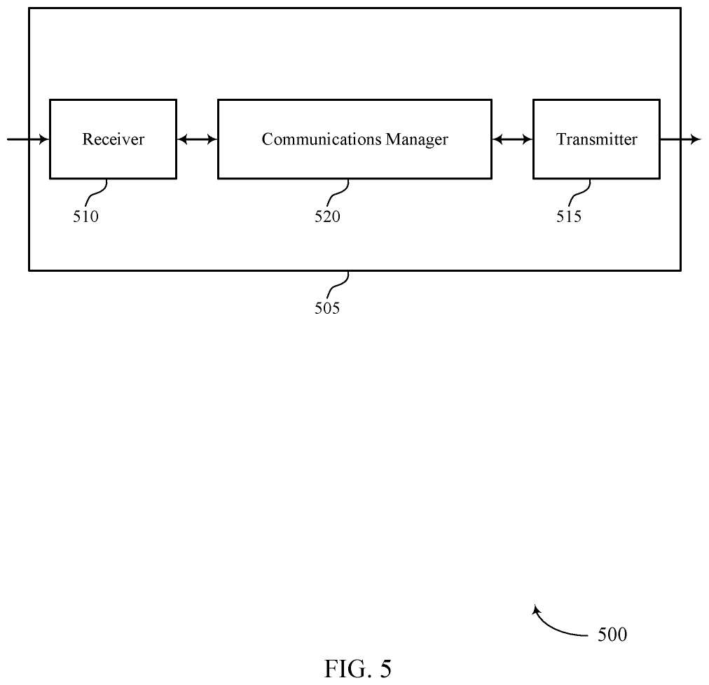

FIG. 5 shows a block diagram 500 of a device 505 that supports radio link control acknowledgement mode timing for multi modal traffic in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of radio link control acknowledgement mode timing for multi modal traffic as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating a first timer corresponding to a radio link control acknowledgement mode, the first timer indicating a threshold amount of time during which the receiving device is to request and monitor for one or more missed packet data units. The communications manager 520 is capable of, configured to, or operable to support a means for receiving one or more packet data units of a first set of packet data units, each packet data unit of the first set of packet data units corresponding to a respective sequence number, where at least a first packet data unit is missing from the first set of packet data units. The communications manager 520 is capable of, configured to, or operable to support a means for initiating the first timer and a second timer upon detecting the first packet data unit is missing. The communications manager 520 is capable of, configured to, or operable to support a means for transmitting, upon expiration of the second timer, a request for a retransmission of the first packet data unit according to the radio link control acknowledgement mode. The communications manager 520 is capable of, configured to, or operable to support a means for delivering the one or more packet data units to higher layers of the receiving device for decoding based on a failure to receive the first packet data unit and expiration of the first timer.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for wireless communications resulting in reduced processing, increased reliability, decreased latency, improved flexibility for improved performance over time, and improved user experience.

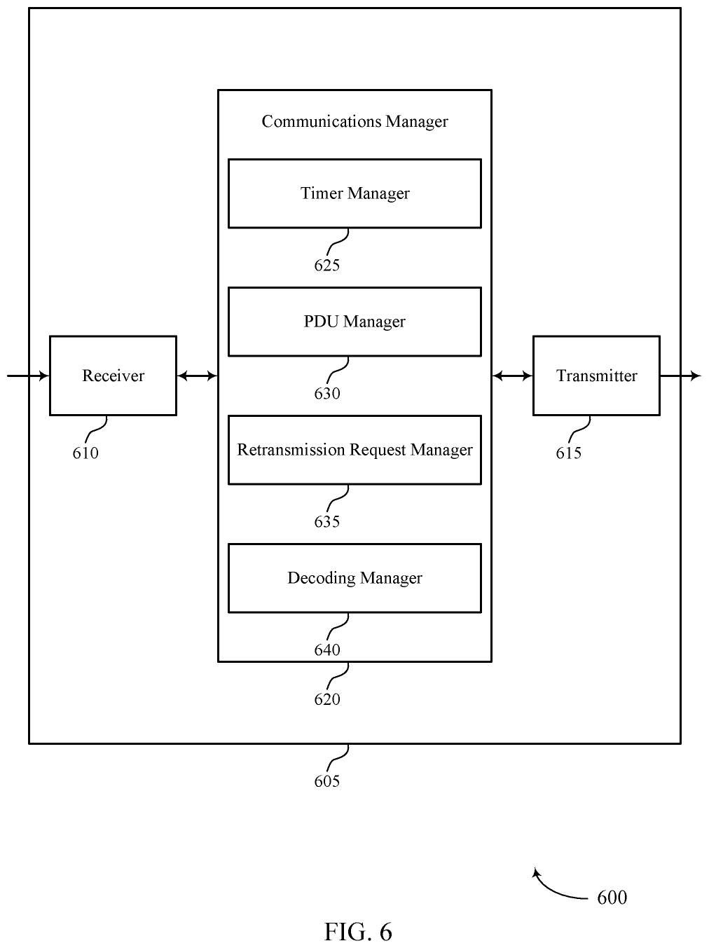

FIG. 6 shows a block diagram 600 of a device 605 that supports radio link control acknowledgement mode timing for multi modal traffic in accordance with one or more aspects of the present disclosure. The device 605 may be an example of aspects of a device 505 or a network entity 105 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of radio link control acknowledgement mode timing for multi modal traffic as described herein. For example, the communications manager 620 may include a timer manager 625, a PDU manager 630, a retransmission request manager 635, a decoding manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The timer manager 625 is capable of, configured to, or operable to support a means for receiving control signaling indicating a first timer corresponding to a radio link control acknowledgement mode, the first timer indicating a threshold amount of time during which the receiving device is to request and monitor for one or more missed packet data units. The PDU manager 630 is capable of, configured to, or operable to support a means for receiving one or more packet data units of a first set of packet data units, each packet data unit of the first set of packet data units corresponding to a respective sequence number, where at least a first packet data unit is missing from the first set of packet data units. The timer manager 625 is capable of, configured to, or operable to support a means for initiating the first timer and a second timer upon detecting the first packet data unit is missing. The retransmission request manager 635 is capable of, configured to, or operable to support a means for transmitting, upon expiration of the second timer, a request for a retransmission of the first packet data unit according to the radio link control acknowledgement mode. The decoding manager 640 is capable of, configured to, or operable to support a means for delivering the one or more packet data units to higher layers of the receiving device for decoding based on a failure to receive the first packet data unit and expiration of the first timer.

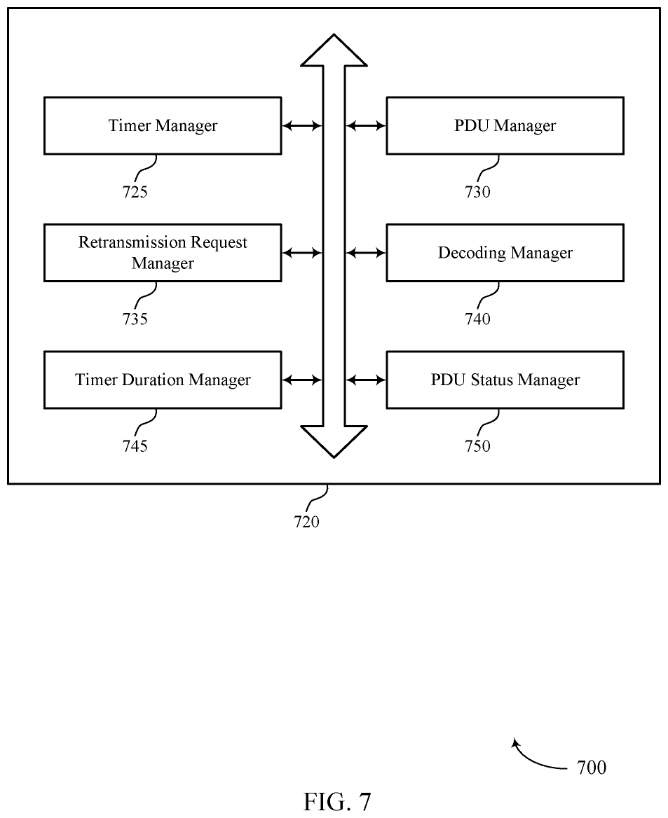

FIG. 7 shows a block diagram 700 of a communications manager 720 that supports radio link control acknowledgement mode timing for multi modal traffic in accordance with one or more aspects of the present disclosure. The communications manager 720 may be an example of aspects of a communications manager 520, a communications manager 620, or both, as described herein. The communications manager 720, or various components thereof, may be an example of means for performing various aspects of radio link control acknowledgement mode timing for multi modal traffic as described herein. For example, the communications manager 720 may include a timer manager 725, a PDU manager 730, a retransmission request manager 735, a decoding manager 740, a timer duration manager 745, a PDU status manager 750, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The timer manager 725 is capable of, configured to, or operable to support a means for receiving control signaling indicating a first timer corresponding to a radio link control acknowledgement mode, the first timer indicating a threshold amount of time during which the receiving device is to request and monitor for one or more missed packet data units. The PDU manager 730 is capable of, configured to, or operable to support a means for receiving one or more packet data units of a first set of packet data units, each packet data unit of the first set of packet data units corresponding to a respective sequence number, where at least a first packet data unit is missing from the first set of packet data units. In some examples, the timer manager 725 is capable of, configured to, or operable to support a means for initiating the first timer and a second timer upon detecting the first packet data unit is missing. The retransmission request manager 735 is capable of, configured to, or operable to support a means for transmitting, upon expiration of the second timer, a request for a retransmission of the first packet data unit according to the radio link control acknowledgement mode. The decoding manager 740 is capable of, configured to, or operable to support a means for delivering the one or more packet data units to higher layers of the receiving device for decoding based on a failure to receive the first packet data unit and expiration of the first timer.

In some examples, the control signaling includes a radio link control configuration information including a semi-static value indicating a duration of the first timer.

In some examples, the control signaling includes a set of candidate timer durations.

In some examples, the timer duration manager 745 is capable of, configured to, or operable to support a means for selecting, from the set of candidate timer durations, a duration of the first timer.

In some examples, to support control signaling, the timer manager 725 is capable of, configured to, or operable to support a means for a first control message including a radio resource control message indicating a first duration of the first timer. In some examples, to support control signaling, the timer manager 725 is capable of, configured to, or operable to support a means for a second control message including a MAC control element (CE) indicating a second duration of the first timer, where the second duration of the first timer overrides the first duration of the first timer, and where initiating the first timer is in accordance with the second duration of the first timer.

In some examples, the timer duration manager 745 is capable of, configured to, or operable to support a means for adjusting a duration of the first timer based on one or more conditions, where initiating the first timer is in accordance with the adjusted duration of the first timer.

In some examples, the one or more conditions include a block error rate corresponding to wireless communications in the radio link control acknowledgement mode, a round trip time corresponding to the wireless communications in the radio link control acknowledgement mode, or both.

In some examples, the control signaling includes a radio link control control packet data unit.

In some examples, the PDU manager 730 is capable of, configured to, or operable to support a means for monitoring for the first packet data unit based on transmitting the request for the retransmission of the first packet data unit, where the failure to receive the first packet data unit is based on the monitoring. In some examples, the PDU status manager 750 is capable of, configured to, or operable to support a means for setting a status of the first packet data unit that is missing to a received status based on expiration of the first timer, where delivering the one or more packet data units to the higher layers of the receiving device for decoding is based on setting the status of the first packet data unit to the received status.

In some examples, a sequence number corresponding to the first packet data unit is lower than at least one sequence number corresponding to another packet data unit of the one or more packet data units.

In some examples, the PDU manager 730 is capable of, configured to, or operable to support a means for monitoring for a second set of packet data units based on delivering the one or more packet data units to higher layers of the receiving device for decoding, where a lowest sequence number corresponding to a first packet data unit of the second set of packet data units is higher than a highest sequence number corresponding to a second packet data unit of the first set of packet data units.

In some examples, the first set of packet data units correspond to multi-modal immersive reality communications including at least visual data and haptic data.

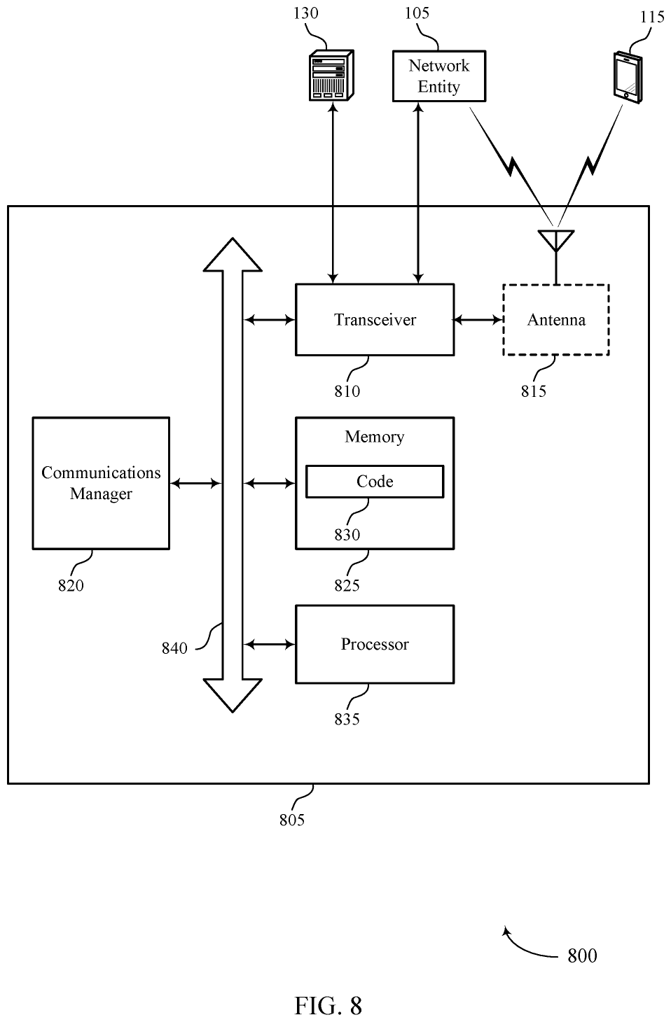

FIG. 8 shows a diagram of a system 800 including a device 805 that supports radio link control acknowledgement mode timing for multi modal traffic in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting radio link control acknowledgement mode timing for multi modal traffic). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving control signaling indicating a first timer corresponding to a radio link control acknowledgement mode, the first timer indicating a threshold amount of time during which the receiving device is to request and monitor for one or more missed packet data units. The communications manager 820 is capable of, configured to, or operable to support a means for receiving one or more packet data units of a first set of packet data units, each packet data unit of the first set of packet data units corresponding to a respective sequence number, where at least a first packet data unit is missing from the first set of packet data units. The communications manager 820 is capable of, configured to, or operable to support a means for initiating the first timer and a second timer upon detecting the first packet data unit is missing. The communications manager 820 is capable of, configured to, or operable to support a means for transmitting, upon expiration of the second timer, a request for a retransmission of the first packet data unit according to the radio link control acknowledgement mode. The communications manager 820 is capable of, configured to, or operable to support a means for delivering the one or more packet data units to higher layers of the receiving device for decoding based on a failure to receive the first packet data unit and expiration of the first timer.

By including or configuring the communications manager 820 in accordance with examples as described herein, the device 805 may support techniques for wireless communications resulting in reduced processing, increased reliability, improved coordination between devices, decreased latency, improved flexibility for improved performance over time, and improved user experience.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of radio link control acknowledgement mode timing for multi modal traffic as described herein, or the at least one processor 835 and the at least one memory 825 may be otherwise configured to, individually or collectively, perform or support such operations.

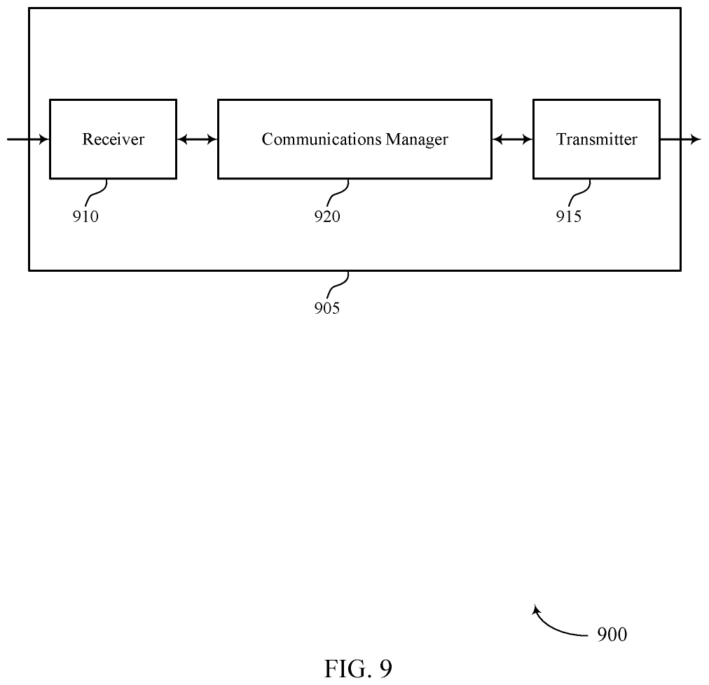

FIG. 9 shows a block diagram 900 of a device 905 that supports radio link control acknowledgement mode timing for multi modal traffic in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to radio link control acknowledgement mode timing for multi modal traffic). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to radio link control acknowledgement mode timing for multi modal traffic). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of radio link control acknowledgement mode timing for multi modal traffic as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for setting, basing at least in part on one or more parameters, a duration of a first timer corresponding to a radio link control acknowledgement mode, the first timer indicating a threshold amount of time during which a receiving device is to request and monitor for one or more missed packet data units. The communications manager 920 is capable of, configured to, or operable to support a means for transmitting control signaling indicating the first timer. The communications manager 920 is capable of, configured to, or operable to support a means for transmitting a first set of packet data units, each packet data unit of the first set of packet data units corresponding to a respective sequence number. The communications manager 920 is capable of, configured to, or operable to support a means for receiving a request for a retransmission of a first packet data unit of the first set of packet data units according to the radio link control acknowledgement mode. The communications manager 920 is capable of, configured to, or operable to support a means for retransmitting the first packet data unit according to the radio link control acknowledgement mode.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for wireless communications resulting in reduced processing, increased reliability, decreased latency, improved flexibility for improved performance over time, and improved user experience.

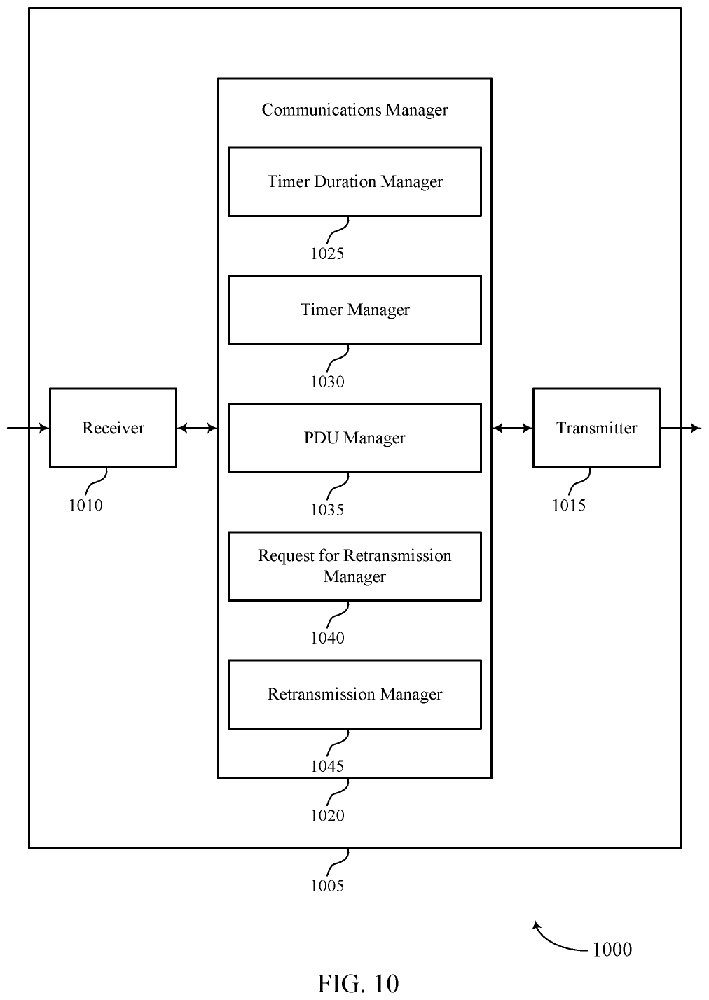

FIG. 10 shows a block diagram 1000 of a device 1005 that supports radio link control acknowledgement mode timing for multi modal traffic in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to radio link control acknowledgement mode timing for multi modal traffic). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to radio link control acknowledgement mode timing for multi modal traffic). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of radio link control acknowledgement mode timing for multi modal traffic as described herein. For example, the communications manager 1020 may include a timer duration manager 1025, a timer manager 1030, a PDU manager 1035, a request for retransmission manager 1040, a retransmission manager 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The timer duration manager 1025 is capable of, configured to, or operable to support a means for setting, based on one or more parameters, a duration of a first timer corresponding to a radio link control acknowledgement mode, the first timer indicating a threshold amount of time during which a receiving device is to request and monitor for one or more missed packet data units. The timer manager 1030 is capable of, configured to, or operable to support a means for transmitting control signaling indicating the first timer. The PDU manager 1035 is capable of, configured to, or operable to support a means for transmitting a first set of packet data units, each packet data unit of the first set of packet data units corresponding to a respective sequence number. The request for retransmission manager 1040 is capable of, configured to, or operable to support a means for receiving a request for a retransmission of a first packet data unit of the first set of packet data units according to the radio link control acknowledgement mode. The retransmission manager 1045 is capable of, configured to, or operable to support a means for retransmitting the first packet data unit according to the radio link control acknowledgement mode.

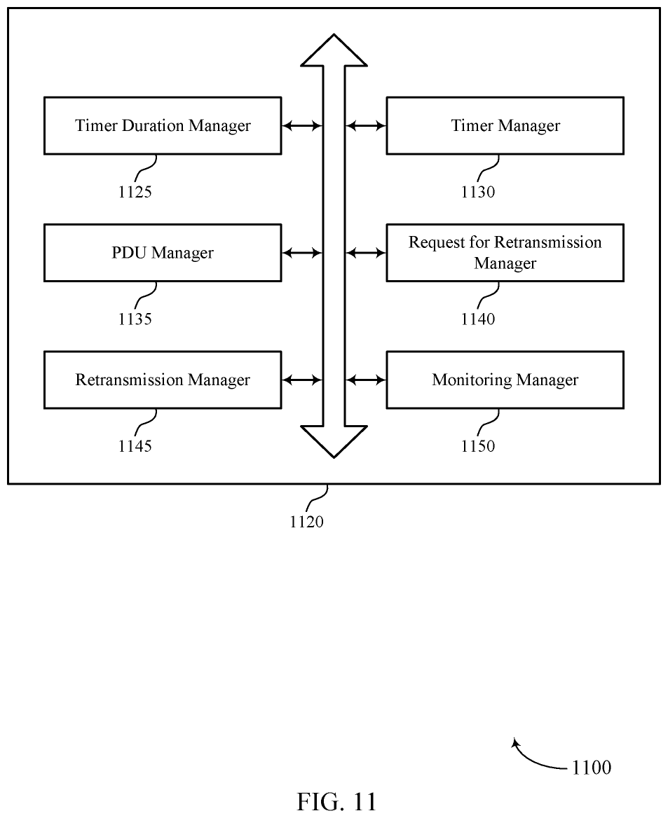

FIG. 11 shows a block diagram 1100 of a communications manager 1120 that supports radio link control acknowledgement mode timing for multi modal traffic in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of radio link control acknowledgement mode timing for multi modal traffic as described herein. For example, the communications manager 1120 may include a timer duration manager 1125, a timer manager 1130, a PDU manager 1135, a request for retransmission manager 1140, a retransmission manager 1145, a monitoring manager 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The timer duration manager 1125 is capable of, configured to, or operable to support a means for setting, based on one or more parameters, a duration of a first timer corresponding to a radio link control acknowledgement mode, the first timer indicating a threshold amount of time during which a receiving device is to request and monitor for one or more missed packet data units. The timer manager 1130 is capable of, configured to, or operable to support a means for transmitting control signaling indicating the first timer. The PDU manager 1135 is capable of, configured to, or operable to support a means for transmitting a first set of packet data units, each packet data unit of the first set of packet data units corresponding to a respective sequence number. The request for retransmission manager 1140 is capable of, configured to, or operable to support a means for receiving a request for a retransmission of a first packet data unit of the first set of packet data units according to the radio link control acknowledgement mode. The retransmission manager 1145 is capable of, configured to, or operable to support a means for retransmitting the first packet data unit according to the radio link control acknowledgement mode.

In some examples, the control signaling includes a radio link control configuration information including a semi-static value indicating the duration of the first timer.

In some examples, the control signaling includes a set of candidate timer durations including the duration of the first timer.

In some examples, to support control signaling, the timer manager 1130 is capable of, configured to, or operable to support a means for a first control message including a radio resource control message indicating an initial duration of the first timer. In some examples, to support control signaling, the timer manager 1130 is capable of, configured to, or operable to support a means for a second control message including a MAC control element (CE) indicating the duration of the first timer, where the duration of the first timer overrides the initial duration of the first timer.

In some examples, the control signaling includes a radio link control control packet data unit.

In some examples, the one or more parameters include quality of service parameters, wireless traffic parameters, quality of service flow identifiers, or any combination thereof.

In some examples, the monitoring manager 1150 is capable of, configured to, or operable to support a means for monitoring for a second request for the retransmission of the first packet data unit according to the radio link control acknowledgement mode for the duration of the first timer. In some examples, the PDU manager 1135 is capable of, configured to, or operable to support a means for transmitting a second set of packet data units based on the monitoring.

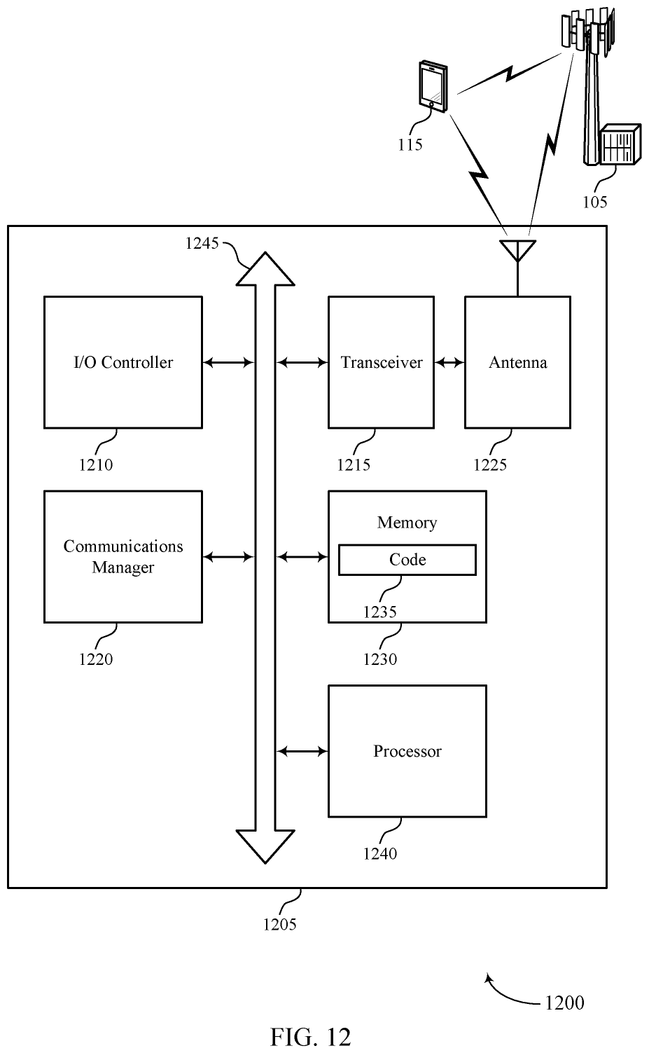

FIG. 12 shows a diagram of a system 1200 including a device 1205 that supports radio link control acknowledgement mode timing for multi modal traffic in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting radio link control acknowledgement mode timing for multi modal traffic). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for setting, basing at least in part on one or more parameters, a duration of a first timer corresponding to a radio link control acknowledgement mode, the first timer indicating a threshold amount of time during which a receiving device is to request and monitor for one or more missed packet data units. The communications manager 1220 is capable of, configured to, or operable to support a means for transmitting control signaling indicating the first timer. The communications manager 1220 is capable of, configured to, or operable to support a means for transmitting a first set of packet data units, each packet data unit of the first set of packet data units corresponding to a respective sequence number. The communications manager 1220 is capable of, configured to, or operable to support a means for receiving a request for a retransmission of a first packet data unit of the first set of packet data units according to the radio link control acknowledgement mode. The communications manager 1220 is capable of, configured to, or operable to support a means for retransmitting the first packet data unit according to the radio link control acknowledgement mode.

By including or configuring the communications manager 1220 in accordance with examples as described herein, the device 1205 may support techniques for wireless communications resulting in reduced processing, increased reliability, improved coordination between devices, decreased latency, improved flexibility for improved performance over time, and improved user experience

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of radio link control acknowledgement mode timing for multi modal traffic as described herein, or the at least one processor 1240 and the at least one memory 1230 may be otherwise configured to, individually or collectively, perform or support such operations.

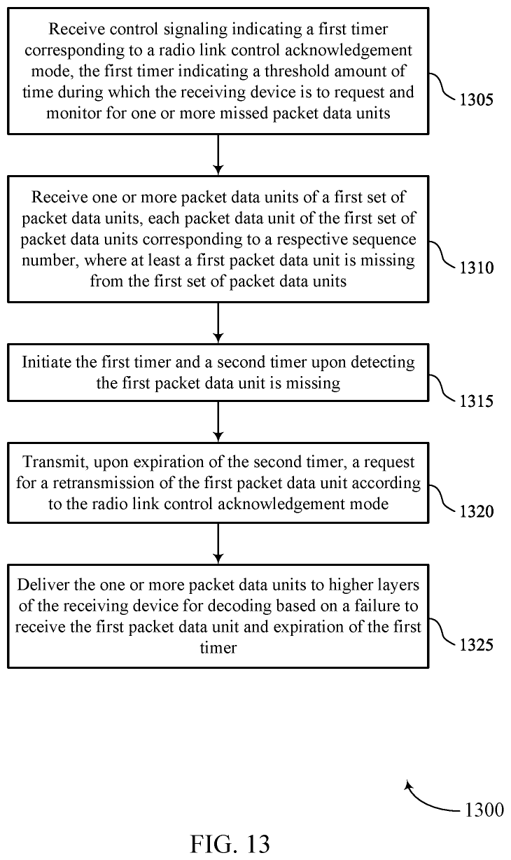

FIG. 13 shows a flowchart illustrating a method 1300 that supports radio link control acknowledgement mode timing for multi modal traffic in accordance with aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include receiving control signaling indicating a first timer corresponding to a radio link control acknowledgement mode, the first timer indicating a threshold amount of time during which the receiving device is to request and monitor for one or more missed packet data units. The operations of block 1305 may be performed in accordance with examples as disclosed herein. In some examples, aspects of the operations of 1305 may be performed by a timer manager 725 as described with reference to FIG. 7.

At 1310, the method may include receiving one or more packet data units of a first set of packet data units, each packet data unit of the first set of packet data units corresponding to a respective sequence number, where at least a first packet data unit is missing from the first set of packet data units. The operations of block 1310 may be performed in accordance with examples as disclosed herein. In some examples, aspects of the operations of 1310 may be performed by a PDU manager 730 as described with reference to FIG. 7.

At 1315, the method may include initiating the first timer and a second timer upon detecting the first packet data unit is missing. The operations of block 1315 may be performed in accordance with examples as disclosed herein. In some examples, aspects of the operations of 1315 may be performed by a timer manager 725 as described with reference to FIG. 7.

At 1320, the method may include transmitting, upon expiration of the second timer, a request for a retransmission of the first packet data unit according to the radio link control acknowledgement mode. The operations of block 1320 may be performed in accordance with examples as disclosed herein. In some examples, aspects of the operations of 1320 may be performed by a retransmission request manager 735 as described with reference to FIG. 7.

At 1325, the method may include delivering the one or more packet data units to higher layers of the receiving device for decoding based on a failure to receive the first packet data unit and expiration of the first timer. The operations of block 1325 may be performed in accordance with examples as disclosed herein. In some examples, aspects of the operations of 1325 may be performed by a decoding manager 740 as described with reference to FIG. 7.

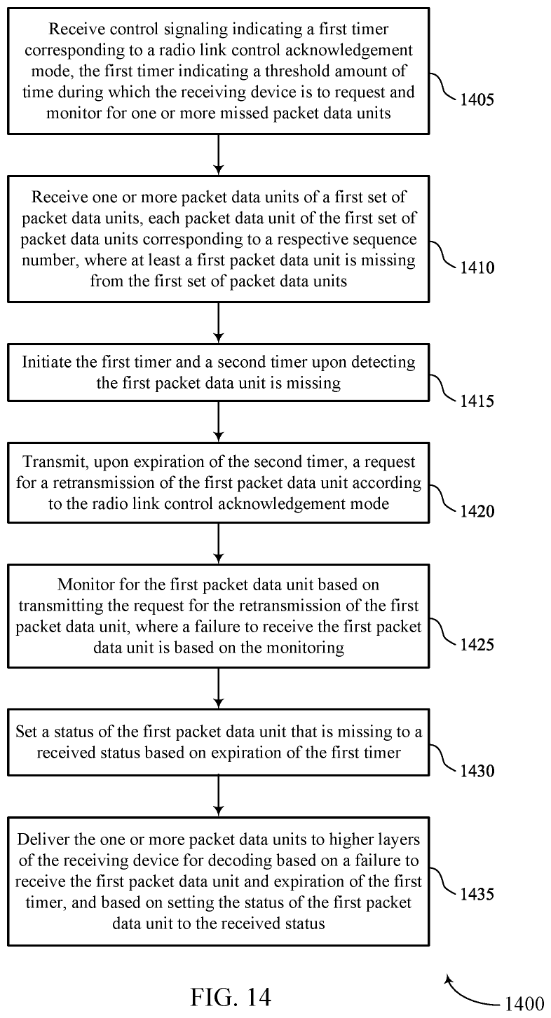

FIG. 14 shows a flowchart illustrating a method 1400 that supports radio link control acknowledgement mode timing for multi modal traffic in accordance with aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include receiving control signaling indicating a first timer corresponding to a radio link control acknowledgement mode, the first timer indicating a threshold amount of time during which the receiving device is to request and monitor for one or more missed packet data units. The operations of block 1405 may be performed in accordance with examples as disclosed herein. In some examples, aspects of the operations of 1405 may be performed by a timer manager 725 as described with reference to FIG. 7.

At 1410, the method may include receiving one or more packet data units of a first set of packet data units, each packet data unit of the first set of packet data units corresponding to a respective sequence number, where at least a first packet data unit is missing from the first set of packet data units. The operations of block 1410 may be performed in accordance with examples as disclosed herein. In some examples, aspects of the operations of 1410 may be performed by a PDU manager 730 as described with reference to FIG. 7.

At 1415, the method may include initiating the first timer and a second timer upon detecting the first packet data unit is missing. The operations of block 1415 may be performed in accordance with examples as disclosed herein. In some examples, aspects of the operations of 1415 may be performed by a timer manager 725 as described with reference to FIG. 7.

At 1420, the method may include transmitting, upon expiration of the second timer, a request for a retransmission of the first packet data unit according to the radio link control acknowledgement mode. The operations of block 1420 may be performed in accordance with examples as disclosed herein. In some examples, aspects of the operations of 1420 may be performed by a retransmission request manager 735 as described with reference to FIG. 7.

At 1425, the method may include monitoring for the first packet data unit based on transmitting the request for the retransmission of the first packet data unit, where a failure to receive the first packet data unit is based on the monitoring. The operations of block 1425 may be performed in accordance with examples as disclosed herein. In some examples, aspects of the operations of 1425 may be performed by a PDU manager 730 as described with reference to FIG. 7.

At 1430, the method may include setting a status of the first packet data unit that is missing to a received status based on expiration of the first timer. The operations of block 1430 may be performed in accordance with examples as disclosed herein. In some examples, aspects of the operations of 1430 may be performed by a PDU status manager 750 as described with reference to FIG. 7.

At 1435, the method may include delivering the one or more packet data units to higher layers of the receiving device for decoding based on a failure to receive the first packet data unit and expiration of the first timer, and based on setting the status of the first packet data unit to the received status. The operations of block 1435 may be performed in accordance with examples as disclosed herein. In some examples, aspects of the operations of 1435 may be performed by a decoding manager 740 as described with reference to FIG. 7.

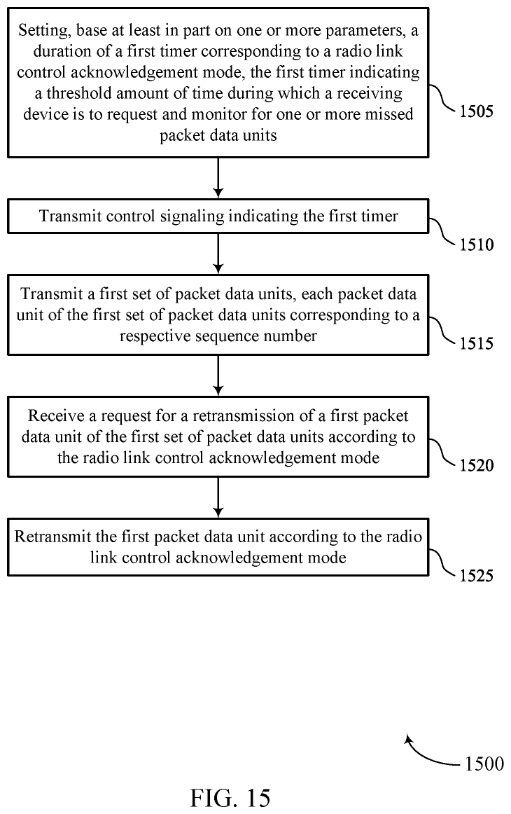

FIG. 15 shows a flowchart illustrating a method 1500 that supports radio link control acknowledgement mode timing for multi modal traffic in accordance with aspects of the present disclosure. The operations of the method 1500 may be implemented by a UE or its components as described herein. For example, the operations of the method 1500 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1505, the method may include setting, based on one or more parameters, a duration of a first timer corresponding to a radio link control acknowledgement mode, the first timer indicating a threshold amount of time during which a receiving device is to request and monitor for one or more missed packet data units. The operations of block 1505 may be performed in accordance with examples as disclosed herein. In some examples, aspects of the operations of 1505 may be performed by a timer duration manager 1125 as described with reference to FIG. 11.

At 1510, the method may include transmitting control signaling indicating the first timer. The operations of block 1510 may be performed in accordance with examples as disclosed herein. In some examples, aspects of the operations of 1510 may be performed by a timer manager 1130 as described with reference to FIG. 11.

At 1515, the method may include transmitting a first set of packet data units, each packet data unit of the first set of packet data units corresponding to a respective sequence number. The operations of block 1515 may be performed in accordance with examples as disclosed herein. In some examples, aspects of the operations of 1515 may be performed by a PDU manager 1135 as described with reference to FIG. 11.

At 1520, the method may include receiving a request for a retransmission of a first packet data unit of the first set of packet data units according to the radio link control acknowledgement mode. The operations of block 1520 may be performed in accordance with examples as disclosed herein. In some examples, aspects of the operations of 1520 may be performed by a request for retransmission manager 1140 as described with reference to FIG. 11.

At 1525, the method may include retransmitting the first packet data unit according to the radio link control acknowledgement mode. The operations of block 1525 may be performed in accordance with examples as disclosed herein. In some examples, aspects of the operations of 1525 may be performed by a retransmission manager 1145 as described with reference to FIG. 11.

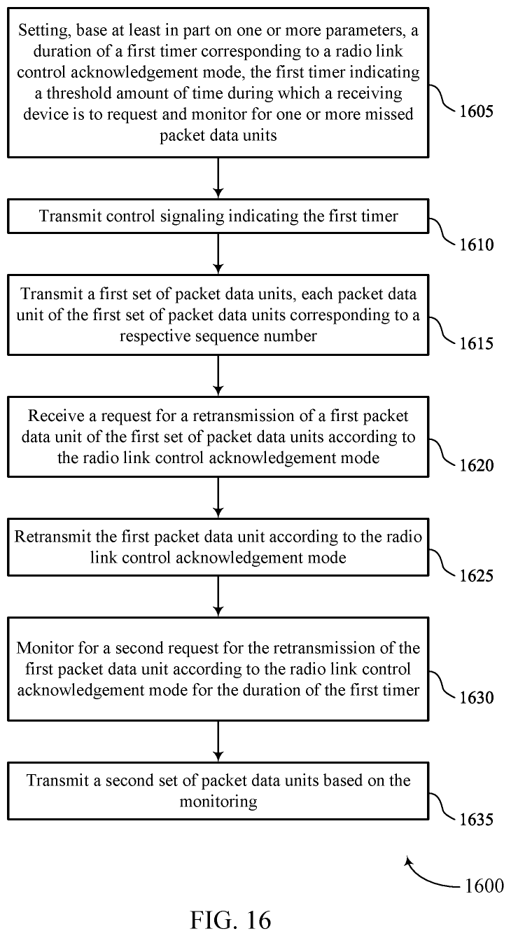

FIG. 16 shows a flowchart illustrating a method 1600 that supports radio link control acknowledgement mode timing for multi modal traffic in accordance with aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1605, the method may include setting, based on one or more parameters, a duration of a first timer corresponding to a radio link control acknowledgement mode, the first timer indicating a threshold amount of time during which a receiving device is to request and monitor for one or more missed packet data units. The operations of block 1605 may be performed in accordance with examples as disclosed herein. In some examples, aspects of the operations of 1605 may be performed by a timer duration manager 1125 as described with reference to FIG. 11.

At 1610, the method may include transmitting control signaling indicating the first timer. The operations of block 1610 may be performed in accordance with examples as disclosed herein. In some examples, aspects of the operations of 1610 may be performed by a timer manager 1130 as described with reference to FIG. 11.

At 1615, the method may include transmitting a first set of packet data units, each packet data unit of the first set of packet data units corresponding to a respective sequence number. The operations of block 1615 may be performed in accordance with examples as disclosed herein. In some examples, aspects of the operations of 1615 may be performed by a PDU manager 1135 as described with reference to FIG. 11.

At 1620, the method may include receiving a request for a retransmission of a first packet data unit of the first set of packet data units according to the radio link control acknowledgement mode. The operations of block 1620 may be performed in accordance with examples as disclosed herein. In some examples, aspects of the operations of 1620 may be performed by a request for retransmission manager 1140 as described with reference to FIG. 11.

At 1625, the method may include retransmitting the first packet data unit according to the radio link control acknowledgement mode. The operations of block 1625 may be performed in accordance with examples as disclosed herein. In some examples, aspects of the operations of 1625 may be performed by a retransmission manager 1145 as described with reference to FIG. 11.

At 1630, the method may include monitoring for a second request for the retransmission of the first packet data unit according to the radio link control acknowledgement mode for the duration of the first timer. The operations of block 1630 may be performed in accordance with examples as disclosed herein. In some examples, aspects of the operations of 1630 may be performed by a monitoring manager 1150 as described with reference to FIG. 11.

At 1635, the method may include transmitting a second set of packet data units based on the monitoring. The operations of block 1635 may be performed in accordance with examples as disclosed herein. In some examples, aspects of the operations of 1635 may be performed by a PDU manager 1135 as described with reference to FIG. 11.

The following provides an overview of aspects of the present disclosure:

Aspect 1: A method for wireless communications at a receiving device, comprising: receiving control signaling indicating a first timer corresponding to a radio link control acknowledgement mode, the first timer indicating a threshold amount of time during which the receiving device is to request and monitor for one or more missed packet data units; receiving one or more packet data units of a first set of packet data units, each packet data unit of the first set of packet data units corresponding to a respective sequence number, wherein at least a first packet data unit is missing from the first set of packet data units; initiating the first timer and a second timer upon detecting the first packet data unit is missing; transmitting, upon expiration of the second timer, a request for a retransmission of the first packet data unit according to the radio link control acknowledgement mode; and delivering the one or more packet data units to higher layers of the receiving device for decoding based at least in part on a failure to receive the first packet data unit and expiration of the first timer.

Aspect 2: The method of aspect 1, wherein the control signaling comprises a radio link control configuration information comprising a semi-static value indicating a duration of the first timer.

Aspect 3: The method of any of aspects 1 through 2, wherein the control signaling comprises a set of candidate timer durations.

Aspect 4: The method of aspect 3, further comprising: selecting, from the set of candidate timer durations, a duration of the first timer.

Aspect 5: The method of any of aspects 1 through 4, wherein the control signaling comprises: a first control message comprising a radio resource control message indicating a first duration of the first timer; and a second control message comprising a MAC control element (CE) indicating a second duration of the first timer, wherein the second duration of the first timer overrides the first duration of the first timer, and wherein initiating the first timer is in accordance with the second duration of the first timer.

Aspect 6: The method of any of aspects 1 through 5, further comprising: adjusting a duration of the first timer based at least in part on one or more conditions, wherein initiating the first timer is in accordance with the adjusted duration of the first timer.

Aspect 7: The method of aspect 6, wherein the one or more conditions comprise a block error rate corresponding to wireless communications in the radio link control acknowledgement mode, a round trip time corresponding to the wireless communications in the radio link control acknowledgement mode, or both.

Aspect 8: The method of any of aspects 1 through 7, wherein the control signaling comprises a radio link control control packet data unit.

Aspect 9: The method of any of aspects 1 through 8, further comprising: monitoring for the first packet data unit based at least in part on transmitting the request for the retransmission of the first packet data unit, wherein the failure to receive the first packet data unit is based at least in part on the monitoring; and setting a status of the first packet data unit that is missing to a received status based at least in part on expiration of the first timer, wherein delivering the one or more packet data units to the higher layers of the receiving device for decoding is based at least in part on setting the status of the first packet data unit to the received status.

Aspect 10: The method of any of aspects 1 through 9, wherein a sequence number corresponding to the first packet data unit is lower than at least one sequence number corresponding to another packet data unit of the one or more packet data units.

Aspect 11: The method of any of aspects 1 through 10, further comprising: monitoring for a second set of packet data units based at least in part on delivering the one or more packet data units to higher layers of the receiving device for decoding, wherein a lowest sequence number corresponding to a first packet data unit of the second set of packet data units is higher than a highest sequence number corresponding to a second packet data unit of the first set of packet data units.

Aspect 12: The method of any of aspects 1 through 11, wherein the first set of packet data units correspond to multi-modal immersive reality communications comprising at least visual data and haptic data.

Aspect 13: A method for wireless communications at a transmitting device, comprising: setting, based at least in part on one or more parameters, a duration of a first timer corresponding to a radio link control acknowledgement mode, the first timer indicating a threshold amount of time during which a receiving device is to request and monitor for one or more missed packet data units; transmitting control signaling indicating the first timer; transmitting a first set of packet data units, each packet data unit of the first set of packet data units corresponding to a respective sequence number; receiving a request for a retransmission of a first packet data unit of the first set of packet data units according to the radio link control acknowledgement mode; and retransmitting the first packet data unit according to the radio link control acknowledgement mode.

Aspect 14: The method of aspect 13, wherein the control signaling comprises a radio link control configuration information comprising a semi-static value indicating the duration of the first timer.

Aspect 15: The method of any of aspects 13 through 14, wherein the control signaling comprises a set of candidate timer durations comprising the duration of the first timer.

Aspect 16: The method of any of aspects 13 through 15, wherein the control signaling comprises: a first control message comprising a radio resource control message indicating an initial duration of the first timer; and a second control message comprising a MAC control element (CE) indicating the duration of the first timer, wherein the duration of the first timer overrides the initial duration of the first timer.

Aspect 17: The method of any of aspects 13 through 16, wherein the control signaling comprises a radio link control control packet data unit.

Aspect 18: The method of any of aspects 13 through 17, wherein the one or more parameters comprise quality of service parameters, wireless traffic parameters, quality of service flow identifiers, or any combination thereof.

Aspect 19: The method of any of aspects 13 through 18, further comprising: monitoring for a second request for the retransmission of the first packet data unit according to the radio link control acknowledgement mode for the duration of the first timer; and transmitting a second set of packet data units based at least in part on the monitoring.

Aspect 20: A receiving device for wireless communications, comprising one or more memories storing processor-executable code, and one or more processors coupled with the one or more memories and individually or collectively operable to execute the code to cause the receiving device to perform a method of any of aspects 1 through 12.

Aspect 21: A receiving device for wireless communications, comprising at least one means for performing a method of any of aspects 1 through 12.

Aspect 22: A non-transitory computer-readable medium storing code for wireless communications, the code comprising instructions executable by one or more processors to perform a method of any of aspects 1 through 12.

Aspect 23: A transmitting device for wireless communications, comprising one or more memories storing processor-executable code, and one or more processors coupled with the one or more memories and individually or collectively operable to execute the code to cause the transmitting device to perform a method of any of aspects 13 through 19.

Aspect 24: A transmitting device for wireless communications, comprising at least one means for performing a method of any of aspects 13 through 19.

Aspect 25: A non-transitory computer-readable medium storing code for wireless communications, the code comprising instructions executable by one or more processors to perform a method of any of aspects 13 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A receiving device, comprising:
one or more memories storing processor-executable code; and
one or more processors coupled with the one or more memories and individually or collectively operable to execute the code to cause the receiving device to:
receive control signaling indicating a first timer corresponding to a radio link control acknowledgement mode, the first timer indicating a threshold amount of time during which the receiving device is to request and monitor for one or more missed packet data units;
receive one or more packet data units of a first set of packet data units, each packet data unit of the first set of packet data units corresponding to a respective sequence number, wherein at least a first packet data unit is missing from the first set of packet data units;
initiate the first timer and a second timer upon detecting the first packet data unit is missing;
transmit, upon expiration of the second timer, a request for a retransmission of the first packet data unit according to the radio link control acknowledgement mode; and
deliver the one or more packet data units to higher layers of the receiving device for decoding based at least in part on a failure to receive the first packet data unit and expiration of the first timer.

2. The receiving device of claim 1, wherein the control signaling comprises a radio link control configuration information comprising a semi-static value indicating a duration of the first timer.

3. The receiving device of claim 1, wherein the control signaling comprises a set of candidate timer durations.

4. The receiving device of claim 3, wherein the one or more processors are individually or collectively further operable to execute the code to cause the receiving device to:
select, from the set of candidate timer durations, a duration of the first timer.

5. The receiving device of claim 1, wherein, to control signal, the one or more processors are individually or collectively operable to execute the code to cause the receiving device to:
a first control message comprises a radio resource control message indicating a first duration of the first timer; and
a second control message comprise a media access control (MAC) control element (CE) indicating a second duration of the first timer, wherein the second duration of the first timer overrides the first duration of the first timer, and wherein initiating the first timer is in accordance with the second duration of the first timer.

6. The receiving device of claim 1, wherein the one or more processors are individually or collectively further operable to execute the code to cause the receiving device to:
adjust a duration of the first timer based at least in part on one or more conditions, wherein initiating the first timer is in accordance with the adjusted duration of the first timer.

7. The receiving device of claim 6, wherein the one or more conditions comprise a block error rate corresponding to wireless communications in the radio link control acknowledgement mode, a round trip time corresponding to the wireless communications in the radio link control acknowledgement mode, or both.

8. The receiving device of claim 1, wherein the control signaling comprises a radio link control control packet data unit.

9. The receiving device of claim 1, wherein the one or more processors are individually or collectively further operable to execute the code to cause the receiving device to:
monitor for the first packet data unit based at least in part on transmitting the request for the retransmission of the first packet data unit, wherein the failure to receive the first packet data unit is based at least in part on the monitoring; and
set a status of the first packet data unit that is missing to a received status based at least in part on expiration of the first timer, wherein delivering the one or more packet data units to the higher layers of the receiving device for decoding is based at least in part on setting the status of the first packet data unit to the received status.

10. The receiving device of claim 1, wherein a sequence number corresponding to the first packet data unit is lower than at least one sequence number corresponding to another packet data unit of the one or more packet data units.

11. The receiving device of claim 1, wherein the one or more processors are individually or collectively further operable to execute the code to cause the receiving device to:
monitor for a second set of packet data units based at least in part on delivering the one or more packet data units to higher layers of the receiving device for decoding, wherein a lowest sequence number corresponding to a first packet data unit of the second set of packet data units is higher than a highest sequence number corresponding to a second packet data unit of the first set of packet data units.

12. The receiving device of claim 1, wherein:
the first set of packet data units correspond to multi-modal immersive reality communications comprising at least visual data and haptic data.

13. A transmitting device, comprising:
one or more memories storing processor-executable code; and
one or more processors coupled with the one or more memories and individually or collectively operable to execute the code to cause the transmitting device to:
setting, base at least in part on one or more parameters, a duration of a first timer corresponding to a radio link control acknowledgement mode, the first timer indicating a threshold amount of time during which a receiving device is to request and monitor for one or more missed packet data units;
transmit control signaling indicating the first timer;
transmit a first set of packet data units, each packet data unit of the first set of packet data units corresponding to a respective sequence number;
receive a request for a retransmission of a first packet data unit of the first set of packet data units according to the radio link control acknowledgement mode; and
retransmit the first packet data unit according to the radio link control acknowledgement mode.

14. The transmitting device of claim 13, wherein the control signaling comprises a radio link control configuration information comprising a semi-static value indicating the duration of the first timer.

15. The transmitting device of claim 13, wherein the control signaling comprises a set of candidate timer durations comprising the duration of the first timer.

16. The transmitting device of claim 13, wherein, to control signal, the one or more processors are individually or collectively operable to execute the code to cause the transmitting device to:
a first control message comprises a radio resource control message indicating an initial duration of the first timer; and
a second control message comprise a media access control (MAC) control element (CE) indicating the duration of the first timer, wherein the duration of the first timer overrides the initial duration of the first timer.

17. The transmitting device of claim 13, wherein the control signaling comprises a radio link control control packet data unit.

18. The transmitting device of claim 13, wherein the one or more parameters comprise quality of service parameters, wireless traffic parameters, quality of service flow identifiers, or any combination thereof.

19. The transmitting device of claim 13, wherein the one or more processors are individually or collectively further operable to execute the code to cause the transmitting device to:
monitor for a second request for the retransmission of the first packet data unit according to the radio link control acknowledgement mode for the duration of the first timer; and
transmit a second set of packet data units based at least in part on the monitoring.

20. A method for wireless communications at a receiving device, comprising:
receiving control signaling indicating a first timer corresponding to a radio link control acknowledgement mode, the first timer indicating a threshold amount of time during which the receiving device is to request and monitor for one or more missed packet data units;
receiving one or more packet data units of a first set of packet data units, each packet data unit of the first set of packet data units corresponding to a respective sequence number, wherein at least a first packet data unit is missing from the first set of packet data units;
initiating the first timer and a second timer upon detecting the first packet data unit is missing;
transmitting, upon expiration of the second timer, a request for a retransmission of the first packet data unit according to the radio link control acknowledgement mode; and
delivering the one or more packet data units to higher layers of the receiving device for decoding based at least in part on a failure to receive the first packet data unit and expiration of the first timer.

21. The method of claim 20, wherein the control signaling comprises a radio link control configuration information comprising a semi-static value indicating a duration of the first timer.

22. The method of claim 20, wherein the control signaling comprises a set of candidate timer durations.

23. The method of claim 20, wherein the control signaling comprises:
a first control message comprising a radio resource control message indicating a first duration of the first timer; and
a second control message comprising a media access control (MAC) control element (CE) indicating a second duration of the first timer, wherein the second duration of the first timer overrides the first duration of the first timer, and wherein initiating the first timer is in accordance with the second duration of the first timer.

24. The method of claim 20, further comprising:
adjusting a duration of the first timer based at least in part on one or more conditions, wherein initiating the first timer is in accordance with the adjusted duration of the first timer.

25. The method of claim 20, wherein the control signaling comprises a radio link control control packet data unit.

26. The method of claim 20, further comprising:
monitoring for the first packet data unit based at least in part on transmitting the request for the retransmission of the first packet data unit, wherein the failure to receive the first packet data unit is based at least in part on the monitoring; and
setting a status of the first packet data unit that is missing to a received status based at least in part on expiration of the first timer, wherein delivering the one or more packet data units to the higher layers of the receiving device for decoding is based at least in part on setting the status of the first packet data unit to the received status.

27. The method of claim 20, wherein a sequence number corresponding to the first packet data unit is lower than at least one sequence number corresponding to another packet data unit of the one or more packet data units.

28. A method for wireless communications at a transmitting device, comprising:
setting, based at least in part on one or more parameters, a duration of a first timer corresponding to a radio link control acknowledgement mode, the first timer indicating a threshold amount of time during which a receiving device is to request and monitor for one or more missed packet data units;
transmitting control signaling indicating the first timer;
transmitting a first set of packet data units, each packet data unit of the first set of packet data units corresponding to a respective sequence number;
receiving a request for a retransmission of a first packet data unit of the first set of packet data units according to the radio link control acknowledgement mode; and
retransmitting the first packet data unit according to the radio link control acknowledgement mode.

29. The method of claim 28, wherein the control signaling comprises a radio link control configuration information comprising a semi-static value indicating the duration of the first timer.

30. The method of claim 28, wherein the control signaling comprises a set of candidate timer durations comprising the duration of the first timer.
